(19) United States
(12) Patent Application Publication
(10) Pub. No.: US 2014/0348090 A1
(43) Pub. Date: Nov. 27, 2014

(54) METHOD OF PROVIDING CONTROL INFORMATION FOR USER EQUIPMENT IN LTE COMMUNICATION SYSTEM

(71) Applicants: Satha SATHANANTHAN, Mulgrave, VIC (AU); Phong NGUYEN, Mulgrave, VIC (AU); NEC CORPORATION, Minato-Ku, Tokyo (JP)

(72) Inventors: Phong Nguyen, Victoria (AU); Satha Sathananthan, Victoria (AU)

(73) Assignee: NEC CORPORATION, Tokyo (JP)

(21) Appl. No.: 14/344,638

(22) PCT Filed: Nov. 6, 2012
(86) PCT No.: PCT/JP2012/007118

§ 371 Date: Mar. 13, 2014

(30) Foreign Application Priority Data
Dec. 2, 2011 (AU) 201190534

(51) Int. Cl. H04W 72/12; H04W 72/04

(52) U.S. Cl. CPC H04W 72/1289; H04W 72/042; H04L 5/003
USPC 370/329

(57) ABSTRACT

There is provided a method implemented in a base station (11) of providing control information to a UE (13) over a wireless communications system (10). This method includes: scrambling (32) an E-PDCCH including the control information; modulating the E-PDCCH; mapping (34) the E-PDCCH on an allocated PRB; and transmitting (12) the E-PDCCH to the UE (13). The UE (13) communicates over the wireless communications system (10) according to the control information.

### TECHNICAL FIELD

The present invention relates to a method of providing control information for User Equipment (UEs) in data communication with an eNodeB over a Long Term Evolution (LTE) wireless communication system, and in particular to using Enhanced Physical Downlink Control Channels (E-PDCCH) for configuring the UEs to communicate data with the eNodeB over the LTE wireless communication system.

### BACKGROUND ART

In existing Long Term Evolution (LTE) wireless communication systems, such as LTE Release 8, 9 and 10, an eNodeB in the LTE system determines which User Equipment (UE) in the system should be granted uplink resources and which UE should be scheduled for transmission in the downlink, and then provides suitable control information for the UEs accordingly. In one example, the eNodeB determines an amount of control channel resources of a Physical Downlink Control Channel (PDCCH) that is required and supported for the UEs comprising this control information. Thus, enhanced use of control channel resources is desired for improved system capabilities.

### SUMMARY OF INVENTION

### Technical Problem

For example, in an LTE communication system, such as an LTE Release 11 system, there has already been extensive discussion about enhanced Enhanced Physical Downlink Control Channels (E-PDCCH) in addition to the Physical Downlink Control Channels (PDCCH). The discussion resulted in specific goals to design E-PDCCH to satisfy the following requirements:

1. support increased control channel capacity;

2. support frequency-domain Inter-Cell Interference Control (ICIC);

3. achieve improved spatial reuse of control channel resource;

4. support beamforming and/or diversity;

5. operate on the new carrier type and in Multicast-Broadcast Single Frequency Network (MBSFN) subframes;

6. coexist on the same carrier as legacy User Equipment (UE).

### Solution to Problem

In an aspect of the present invention, there is provided a method of providing control information for UEs in data communication with an eNodeB over a Long Term Evolution (LTE) wireless communication system, the method comprising: encoding at least one Enhanced Physical Downlink Control Channel (E-PDCCH) comprising the control information for configuring the UEs to communicate data with the eNodeB over the LTE wireless communication system; mapping the at least one E-PDCCH on at least one allocated Physical Resource Block (PRB); and communicating the at least one E-PDCCH mapped on the at least one allocated PRB to the UEs so that the UEs can be configured to communicate said data over the LTE wireless communication system based on the control information.

In an embodiment, the eNodeB encodes and maps the E-PDCCH to the PRB(s) for downlink control of each UE in data communication with the eNodeB. In addition to the E-PDCCH, a Physical Downlink Control Channel (PDCCH) also includes downlink control information, as well as scheduling downlink information and, in one arrangement, scheduling uplink information for data communication with the eNodeB. The E-PDCCH extends the capabilities of the PDCCH and, in one arrangement, conveys both uplink scheduling information and downlink L1/L2 control signalling, in the form of downlink control information (DCI), for the UEs.

In an embodiment, the Long Term Evolution (LTE) wireless communication system comprises Release 11 LTE. It will be appreciated by those persons skilled in the art that the UEs can operate on other release LTE's, particularly beyond Release 11. Thus, in the embodiment, the method improves system capacity for control channel(s) in UEs supporting Release 11 LTE without impacting on the control channel capacity currently supporting Release 8, Release 9 and Release 10 UEs, (e.g. increasing control channel capacity). Also, in an embodiment, the method resolves the issue of having the same transmission mode for the Release 11 control channel(s) and legacy control channel(s) by providing the Release 11 control channel as a new transmission mode thereby improving performance. The method can, for example, now achieve, based on the E-PDCCH coding structure, improved spatial reuse of control channel resources and can support Release 11 supported technologies such as higher modulation schemes, beamforming, Multi User Multiple Input Multiple Output MU-MIMO communication systems (e.g. 2 codewords), and multi layers.

In an embodiment, the method further comprises encoding the at least one Enhanced Physical Downlink Control Channel (E-PDCCH) to form an E-PDCCH coding structure by performing legacy PDCCH coding chain functions on the downlink control information (DCI), Control Channel Elements (CCE) aggregation and E-PDCCH multiplexing to enhance the legacy PDDCH coding chain functions, scrambling to accommodate a Multi User Multiple Input Multiple Output (MU MIMO) LTE wireless communication system, higher modulation schemes to improve E-PDCCH throughput, interleaving to improve time and frequency gain of the at least one E-PDCCH modulated by the modulation step, and layer mapping and precoding to allow the at least one E-PDCCH to operate with Demodulation Reference Signal (DMRS) and beamforming

In an embodiment, the E-PDCCH is mapped on the at least one allocated PRB and communicated to the UEs according to various methods.

In an embodiment, the method further comprises mapping the at least one E-PDCCH on said at least one allocated PRB using a single carrier component of the LTE wireless communication system.

In an embodiment, the method further comprises mapping the at least one E-PDCCH on said at least one allocated Physical Resource Block (PRB) using intra carrier mapping of the single carrier component.

In an embodiment, the method further comprises mapping the at least one E-PDCCH on said at least one allocated Physical Resource Block (PRB) on a primary carrier component of the LTE wireless communication system to provide full cross carrier scheduling on Physical Downlink Shared Channel (PDSCH) and/or Physical Uplink Shared Channel (PUSCH).

In an embodiment, the method further comprises mapping the at least one E-PDCCH on said at least one allocated Physical Resource Block (PRB) on a secondary carrier component of the LTE wireless communication system to provide semi cross carrier scheduling on Physical Downlink Shared Channel (PDSCH) and/or Physical Uplink Shared Channel (PUSCH).

In an embodiment, the method further comprises mapping the at least one E-PDCCH on said at least one allocated Physical Resource Block (PRB) on a primary carrier component of the LTE wireless communication system to provide intra carrier and cross carrier scheduling on Physical Downlink Shared Channel (PDSCH) and/or Physical Uplink Shared Channel (PUSCH).

In an embodiment, the method further comprises mapping the multiple E-PDCCHs on multiple ones of the allocated Physical Resource Blocks (PRB) on a primary carrier component and a secondary carrier component of the LTE wireless communication system to provide both intra carrier and cross carrier scheduling of Physical Downlink Shared Channel (PDSCH) and/or Physical Uplink Shared Channel (PUSCH).

In an embodiment, the above described different methods of mapping the E-PDCCH onto allocated PRB(s) can be dynamically configured on a sub-frame basis. In one arrangement, for example, the mapping comprises Time-Frequency mapping on allocated PRBs on existing legacy systems, such as LTE Release 8, 9 and 10, including non-carrier aggregation and carrier aggregation with or without cross carrier scheduling, and is applicable to additional carrier types including extension carrier and carrier segments. In addition, the allocated PRB for the E-PDCCH can be used for both localised mapping and distributed mapping.

In an embodiment, the LTE wireless communication system comprises one or more cells, such as a Primary cell (Pcell), and a Secondary cell (SCell), supported by the eNodeB, and the E-PDCCH comprises information indicating which cell is to be used for L1 data communication between the eNodeB and UEs. In addition, or in the alternative, the PDCCH comprises information indicating which cell is to be used for E-PDCCH(s) communication between the eNodeB and UEs.

In an embodiment, the method allows frequency-domain Inter-Cell Interference Control (ICIC) to be applied for mitigating inter-cell interference and both time and frequency diversity to be achieved.

In an embodiment, the UE is configured to receive a Physical Downlink Shared Channel (PDSCH) and/or transmit a Physical Uplink Shared Channel (PUSCH) being scheduled on the Primary Cell (Pcell), or the Secondary Cell (SCell), or both Pcell and SCell, using Guiding PDCCH and E-PDCCH. In an arrangement, the E-PDCCH includes an Enhanced Radio Network Temporary Identifier (E-RNTI), and the method includes assigning the E-RNTI to Release 11 capable UEs. Also, new downlink control information (DCI) for the UEs can be sent on a PDCCH in the form of a Guiding PDCCH, and the UEs are configured to receive the PDSCH with or without the assigned E-RNTI.

In an embodiment, the method further comprises mapping in a common search space of a primary carrier component a Guiding PDCCH comprising enhanced downlink control information (E-DCI) for the UEs to decode the at least one E-PDCCH on said at least one allocated Physical Resource Block (PRB) on a primary carrier component and/or a secondary carrier component of the LTE wireless communication system. In the embodiment, the UE detects the Guiding PDCCH, and performs E-DCI decoding on the Guiding PDCCH to receive E-PDCCH for configuring the UE to communicate data with the eNodeB over the LTE wireless communication system.

In an embodiment, the Guiding PDCCH comprises a Cyclic Redundancy Check (CRC) that is scrambled with an assigned Enhanced Dedicated Channel Radio Network Temporary Identifier (E-RNTI).

In an embodiment, the method further comprises assigning the E-RNTI to LTE Release 11 capable UEs in the LTE wireless communication system. In one arrangement, the method further comprises assigning the LTE Release 11 capable UEs to a Cell Radio Network Temporary Identifier (C-RNTI) and assigning the E-RNTI thereto so that the LTE Release 11 capable UEs receives and decodes associated one or more Physical Downlink Shared Channel (PDSCH) and/or Physical Uplink Shared Channel (PUSCH) based on the received DCI. In another arrangement, the method further comprises assigning the LTE Release 11 capable UEs to a Cell Radio Network Temporary Identifier (C-RNTI) and not assigning the E-RNTI thereto so that the LTE Release 11 capable UEs receive and decode associated one or more Physical Downlink Shared Channel (PDSCH) and/or Physical Uplink Shared Channel (PUSCH) in the same way as for the legacy UEs in the LTE wireless communication system.

In another aspect of the present invention there is provided a User Equipment (UE) in data communication with an eNodeB over a Long Term Evolution (LTE) wireless communication system, the UE comprising: a controller configured to: receive at least one Enhanced Physical Downlink Control Channel (E-PDCCH) comprising control information for configuring the UE to communicate data with the eNodeB over the LTE wireless communication system, the at least one E-PDCCH being mapped on at least one allocated Physical Resource Block (PRB); and configure the UE for communicating data with the eNodeB over the LTE wireless communication system based on the control information.

In further another aspect of the present invention, there is provided a method implemented in a base station of providing control information to a user equipment (UE) over a wireless communications system. This method includes: scrambling an enhanced physical down link control channel (E-PDCCH) comprising the control information; modulating the E-PDCCH; mapping the E-PDCCH on an allocated physical resource block (PRB); and transmitting the E-PDCCH to the UE. The UE communicates over the wireless communications system according to the control information.

In this method, both localised and distributed transmission may be supported for the E-PDCCH.

In this method, the E-PDCCH may be mapped to the allocated PRB for localised and distributed transmission.

In this method, mapping the E-PDCCH on the allocated PRB may be dynamically configured.

In this method, the dynamic configuration may be on a sub-frame basis.

This method may further include: mapping the E-PDCCH on the allocated PRB using a single carrier component of the wireless communications system.

This method may further include: mapping the E-PDCCH on the allocated PRB using intra carrier mapping of the single carrier component.

This method may further include: mapping the E-PDCCH on the allocated PRB on a secondary carrier component of the wireless communications system; and providing semi cross carrier scheduling on at least one of physical down link shared channel (PDSCH) and physical uplink shared channel (PUSCH).

This method may further include: mapping the E-PDCCH on the allocated PRB on a primary carrier component of the wireless communications system; and providing full cross carrier scheduling on at least one of physical down link shared channel (PDSCH) and physical uplink shared channel (PUSCH).

This method may further include: mapping the E-PDCCH on the allocated PRB on a primary carrier component of the wireless communications system; and providing intra carrier and cross carrier scheduling on at least one of physical down link shared channel (PDSCH) and physical uplink shared channel (PUSCH).

This method may further include: mapping multiple E-PDCCHs on using a primary carrier component and a secondary carrier component of the wireless communications system; and providing intra carrier and cross carrier scheduling on at least one of physical down link shared channel (PDSCH) and physical uplink shared channel (PUSCH).

This method may further include: mapping in a common search space of a primary carrier component a guiding PDCCH comprising enhanced downlink control information (E-DCI) for the UE. In this case, the UE decodes the E-PDCCH on the allocated PRB on at least one of a primary carrier component and a secondary carrier component of the wireless communications system.

In this method, the guiding PDCCH may includes a cyclic redundancy check (CRC). In this case, the CRC is scrambled with an assigned enhanced dedicated channel radio network temporary identifier (E-RNTI).

This method may further include: assigning the E-RNTI to a UE in the wireless communications system.

This method may further include: assigning a cell radio network temporary identifier (C-RNTI) to the UE; and assigning the E-RNTI to the UE. In this case, the UE receives at least one of physical downlink shared channel (PDSCH) and physical uplink shared channel (PUSCH) and decodes said at least one of PDSCH and PUSCH according to the DCI.

This method may further include: encoding the E-PDCCH to form an E-PDCCH coding structure by performing at least one of 1) a PDCCH coding chain function on the control information,

2) Control Channel Element (CCE) aggregation and E-PDCCH multiplexing to enhance the PDDCH coding chain function,

3) scrambling to accommodate a multi user multiple input multiple output (MU-MIMO) wireless communications system,

4) a higher modulation scheme to improve E-PDCCH throughput,

5) interleaving to improve time and frequency gain of the E-PDCCH, and

6) layer-mapping and precoding to allow the E-PDCCH to operate with demodulation reference signal (DMRS) and beamforming

In further another aspect of the present invention, there is provided a method implemented in a user equipment (UE) of receiving control information from a base station over a wireless communications system. This method includes: receiving an enhanced physical down link control channel (E-PDCCH) from the base station; and communicating over the wireless communications system according to the control information. The E-PDCCH comprises the control information, and the E-PDCCH is scrambled and modulated by the base station and mapped on an allocated physical resource block (PRB) by the base station.

In this method, both localised and distributed transmission may be supported for the E-PDCCH.

In this method, the E-PDCCH may be mapped to the allocated PRB for localised and distributed transmission.

In further another aspect of the present invention, there is provided a method implemented in a wireless communications system of providing control information from a base station to a user equipment (UE). This method includes: scrambling an enhanced physical down link control channel (E-PDCCH) comprising the control information; modulating the E-PDCCH; mapping the E-PDCCH on an allocated physical resource block (PRB); transmitting the E-PDCCH from the base station to the UE; and communicating over the wireless communications system according to the control information.

In this method, both localised and distributed transmission may be supported for the E-PDCCH.

In this method, the E-PDCCH may be mapped to the allocated PRB for localised and distributed transmission.

In further another aspect of the present invention, there is provided a base station of providing control information to a user equipment (UE) over a wireless communications system. This base station includes: a scrambling unit to scramble an enhanced physical down link control channel (E-PDCCH) comprising the control information; a modulation unit to modulate the E-PDCCH; a mapping unit to map the E-PDCCH on an allocated physical resource block (PRB); and a transmitter to transmit the E-PDCCH to the UE. The UE communicates over the wireless communications system according to the control information.

In this base station, both localised and distributed transmission may be supported for the E-PDCCH.

In this base station, the E-PDCCH may be mapped to the allocated PRB for localized and distributed transmission.

In further another aspect of the present invention, there is provided a user equipment (UE) of receiving control information from a base station over a wireless communications system. This UE includes: a receiving unit to receive an enhanced physical down link control channel (E-PDCCH) from the base station; and a controller to communicate over the wireless communications system according to the control information. The E-PDCCH includes the control information, and the E-PDCCH is scrambled and modulated by the base station and mapped on an allocated physical resource block (PRB) by the base station.

In this UE, both localised and distributed transmission may be supported for the E-PDCCH.

In this UE, the E-PDCCH may be mapped to the allocated PRB for localized and distributed transmission.

### Advantageous Effects of Invention

According to the present invention, it is possible to satisfy at least one of the above-mentioned requirements.

### BRIEF DESCRIPTION OF DRAWINGS

FIG. 1 is a schematic illustration of a Long Term Evolution (LTE) wireless communication system according to an embodiment of the present invention.

FIG. 2 is a graphical illustration of a Primary cell (Pcell) showing E-PDCCH mapping comprising single carrier or intra carrier mapping according to an embodiment of the present invention.

FIG. 3 is a graphical illustration of a Primary cell (Pcell) and a Secondary cell (Scell) showing E-PDCCH mapping on Pcell to provide full cross carrier scheduling of PDSCH and/or PUSCH according to an embodiment of the present invention.

FIG. 4 is a graphical illustration of a Primary cell (Pcell) and a Secondary cell (Scell) showing E-PDCCH mapping on Scell to provide semi cross carrier scheduling of PDSCH and/or PUSCH according to an embodiment of the present invention.

FIG. 5 is a graphical illustration of a Primary cell (Pcell) and a Secondary cell (Scell) showing E-PDCCH mapping on Pcell to provide a mix of intra carrier and cross carrier scheduling of PDSCH and/or PUSCH according to an embodiment of the present invention.

FIG. 6 is a graphical illustration of a Primary cell (Pcell) and a Secondary cell (Scell) showing E-PDCCH mapping on Pcell and Scell to provide a mix of intra carrier and cross carrier scheduling of PDSCH and/or PUSCH according to an embodiment of the present invention.

FIG. 7 is a flow chart illustrating encoding E-PDCCH according to an embodiment of the present invention.

FIG. 8A is a flow chart illustrating a UE accessing a LTE system and receiving E-PDCCH according to an embodiment of the present invention.

FIG. 8B is a flow chart illustrating a UE accessing a LTE system and receiving E-PDCCH according to an embodiment of the present invention.

### DESCRIPTION OF EMBODIMENTS

Embodiments of the present invention will now be described, by way of example only, with reference to the accompanying drawings.

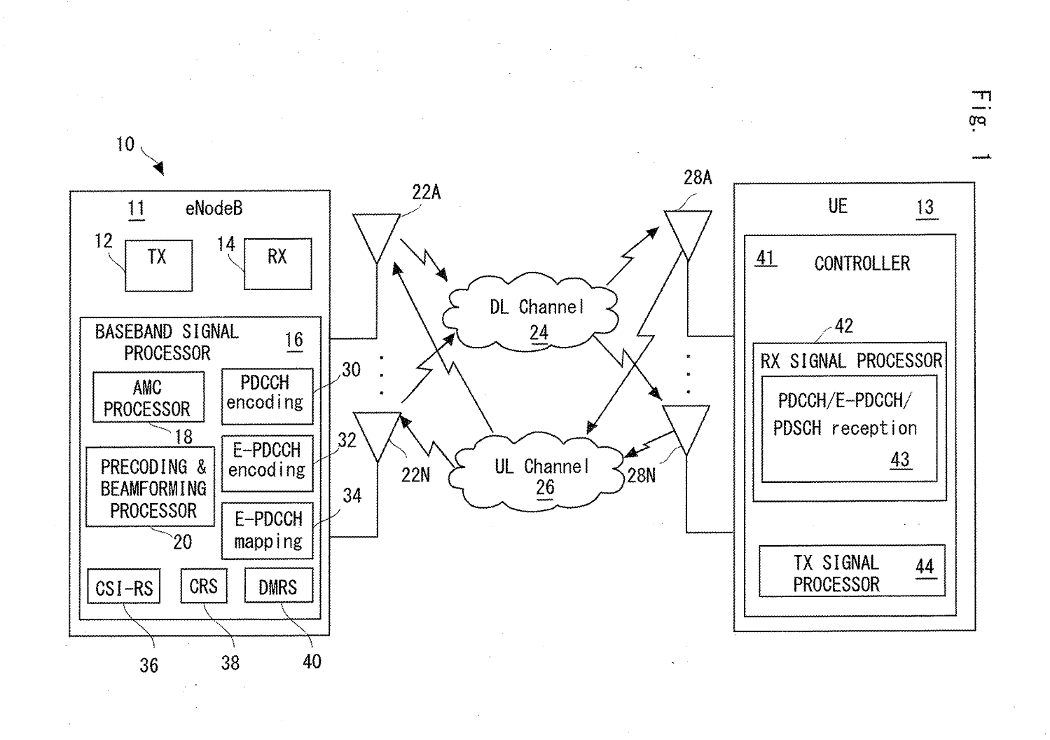

According to an embodiment, there is provided an LTE wireless communication system 10 as shown in FIG. 1. In the embodiment, the system 10 comprises LTE Release 11 and is a multiple input/multiple output (MIMO) communication system comprising a base station (eNodeB) 11 and at least one User Equipment (UE) 13. The system 10 also includes Channel State Information Reference Signals (CSI-RS), configured by a CSI-RS module 36 at the eNodeB 11, for use at the UE 13, as a reference to perform Channel State Information (CSI) calculations which are to be fed back to the eNodeB 11 for downlink data communication control. Also, to support the multiple antennas of the MIMO system, Cell-Specific Reference Signals (CRS) and Demodulation Reference Signals (DMRS), configured by CRS 38 and DMRS 40 modules at the eNodeB 11, are used by the system 10.

Also in the embodiment, the eNodeB 11 comprises a number of further components or modules to communicate data with the UE 13 over downlink (DL) 24 and uplink (UL) 26 channels including a transmitter controller TX 12 and a receiver controller RX 14 arranged to control eNodeB antennas 22A to 22N to transmit/receive data. Also, the eNodeB 11 includes a baseband signal processor 16 which includes an AMC (Adaptive Modulation and Coding) processor 18 and a precoding and beamforming processor 20. It can be seen from FIG. 1 that the UE 13 of the system 10 also has a number of antennas 28A to 28N arranged to operate with respect to components or modules of the UE 13 to communicate data with the eNodeB 11. These modules include a receiver signal processor 42 and a transmitter signal processor 44 to receive and transmit data to/from the eNodeB 11.

In order to control data communication between the UE 13 and the eNodeB 11, control information is communicated to the UE 13. In legacy LTE systems, Physical Downlink Control Channel (PDCCH) information is transmitted to the UE 13 for scheduling uplink and downlink data communication with the eNodeB 11. The system 10, in the embodiment, also includes Enhanced Physical Downlink Control Channels (E-PDCCH) comprising the control information to extend the capabilities of the PDCCH(s) whilst proving legacy support for legacy UEs in the system 10. The E-PDCCH for configuring the UE 13 to communicate data with the eNodeB 11 over the system 10 are encoded by the eNodeB 11 at an E-PDCCH encoding module 32, along with PDCCH which are encoded at a PDCCH encoding module 30. The at least one E-PDCCH is then mapped on at least one allocated Physical Resource Block (PRB) by an E-PDCCH mapping module 34 and the at least one E-PDCCH is communicated to the UE 13 so that the UE 13, and each of the UEs not shown in this Figure, can be configured to communicate data over the system 10.

The UE 13 comprises a number of further components to receive the E-PDCCH and to configure the UE 13 to communicate data over the system 10. In use, a controller 41 is configured to control the receiver signal processor 42 to receive the E-PDCCH mapped on PRB(s) from the eNodeB 11 over at least one downlink channel 24 therebetween. The receiver signal processor 42 also includes a PDCCH/E-PDCCH/Physical Downlink Shared Channel (PDSCH) reception module 43 configured to receive PDCCH sent on L1/L2 control region and PRB(s) having E-PDCCH/PDSCH mapped thereon and to extract the control information on the PDCCH/E-PDCCH/PDSCH so that the controller 41 can configure the UE 13, and the antennas 28A 28N of the UE 13, to communicate data with the eNodeB 11 over the system 10.

As described, the system 10 increases system capacity without creating an impact on the legacy system (e.g. LTE Release 8, 9 and 10) using the E-PDCCH to support increased control channel capacity, frequency-domain ICIC, achieve improved spatial reuse of control channel resource, support beamforming and/or diversity, operate on new carrier types and in MBSFN sub-frames, coexist on the same carrier as legacy UEs, schedule frequency-selectively, and mitigate inter-cell interference. The E-PDCCH is, in an embodiment of the present invention, Time-Frequency mapped onto the existing legacy LTE systems according to different methods including non-carrier aggregation and carrier aggregation, with or without cross carrier scheduling, and is applicable to additional carrier types including extension carrier and carrier segments.

As described, the LTE wireless communication system 10 comprises a carriers in the form of a Primary cell (Pcell) and a Secondary cell (SCell), which are supported by the eNodeB 11, and the E-PDCCH comprises information indicating which cell is to be used for L1 data communication by the UEs.

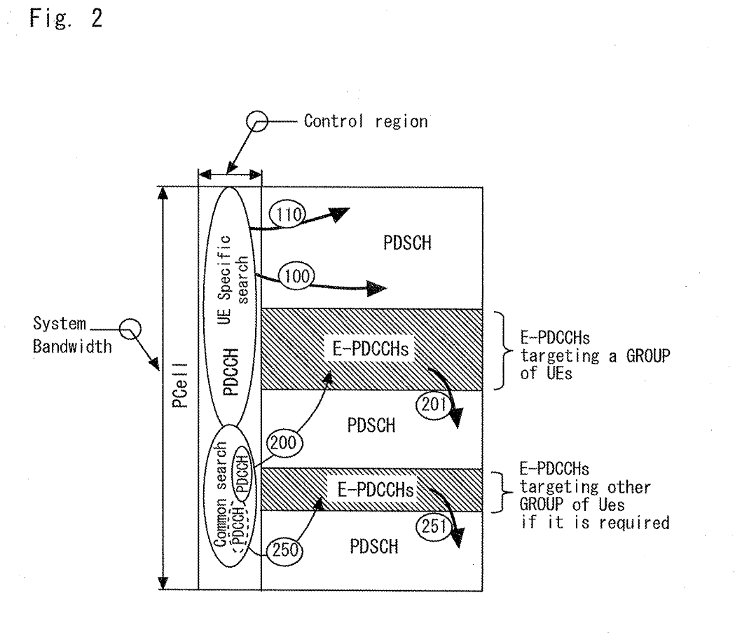

In use, a first method of mapping E-PDCCH(s) by the E-PDCCH mapping module 34 of the eNodeB 11 comprises the E-PDCCH(s) being mapped:
on a Primary carrier component or Primary Cell (Pcell) of the LTE system to provide L1 control information for the reception/transmission and decoding/encoding of the associating PDSCH(s)/PUSCH(s) scheduled on the Pcell as illustrated as item (201) and/or (251) in FIG. 2
on a PRB (Physical Resource Block) basis
on a single slot of a sub-frame or across two slots of a sub-frame on the same PRB aiming to achieve time diversity
on a group of localised or distributed PRB(s) aiming to achieve frequency beamforming gain or frequency diversity respectively, as well as to support frequency domain ICIC
in a region that is not occupied by a L1/2 Control Region of the Pcell so that there is no impact on the legacy PDCCH
on a group of PRB(s) by a group of PRB(s) basis, with each group of PRB(s) carrying E-PDCCH(s) for being monitored and blind decoded by a specific group of UEs which are subjected to similar channel conditions
on RE(s) (Resource Element) which are not reserved for CRS (Cell Reference Signal), PRS (Positioning Reference Signal), CSI-RS (Channel State Information Reference Signal), PSS (Primary Synchronisation Signal), and SSS (Secondary Synchronisation Signal).

Also, if a sub-frame is the sub-frame 0, E-PDCCH(s) shall not be mapped in the PRB(s) that carry the PBCH and, if the frame structure is type 2, E-PDCCH(s) shall not be mapped on special sub-frames.

The location of a group of PRB(s) carrying E-PDCCH(s) intended for a group of UEs is communicated to that specific group of UEs via a single legacy PDCCH in the form of a Guiding PDCCH, which is transmitted in the common search space within the Pcell control region. This is illustrated as item (200) in FIG. 2. If multiple groups of PRBs carrying E-PDCCH(s) are intended for multiple groups of UEs, the Guiding PDCCHs can be jointly coded to save space (or can be separately coded). This is illustrated as items (200) and/or (250) in FIG. 2. Thus, it can be seen that, using this method of mapping, legacy UE(s) can be operated in the system 10 and the physical channels are mapped as per normal in the Pcell regardless of the existence of Release 11 LTE capable UE(s) in the system 10.

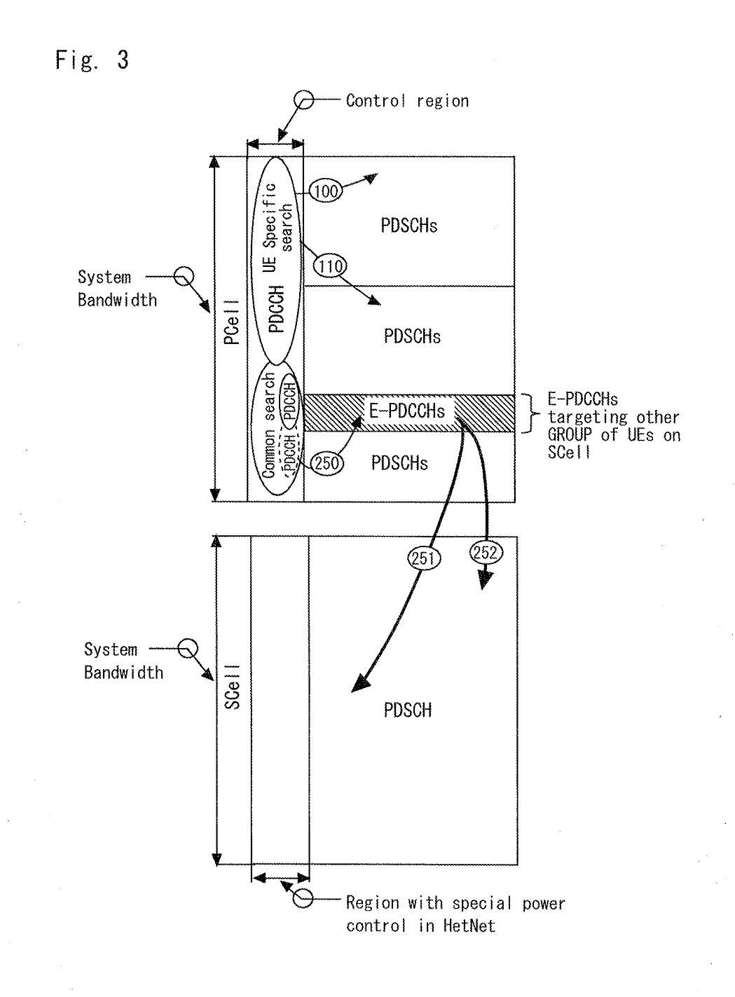

A second method of mapping E-PDCCH(s) by the E-PDCCH mapping module 34 of the eNodeB 11 is exemplary illustrated in FIG. 3 and supports carrier aggregation with full cross carrier scheduling. In this method, the E-PDCCH(s) is mapped:
on a Primary carrier component or Primary Cell (Pcell) of the LTE system to provide L1 control information for the reception/transmission and decoding/encoding of the associating PDSCH(s)/PUSCH(s) scheduled on a secondary carrier component or Secondary Cell (SCell) of the LTE system—this is the case for carrier aggregation with full cross carrier scheduling—as illustrated as item (251) and/or (252) in FIG. 3
on a PRB (Physical Resource Block) basis
on a single slot of a sub-frame or across two slots of a sub-frame on the same PRB aiming to achieve time diversity
on a group of localised or distributed PRBs aiming to achieve frequency beamforming gain or frequency diversity respectively, as well as to support frequency domain ICIC
in a region that is not occupied by L1/2 Control Region of the Pcell so there is no impact on the legacy PDCCH
on a group of PRB(s) by group of PRB(s) basis with each group of PRB(s) carrying E-PDCCH(s) for being monitored and blind decoded by a specific group of UEs which are subjected to similar channel conditions
on RE(s) (Resource Element) which are not reserved for CRS (Cell Reference Signal), PRS (Positioning Reference Signal), CSI-RS (Channel State Information Reference Signal), PSS (Primary Synchronisation Signal), and SSS (Secondary Synchronisation Signal).

Also, if a sub-frame is the sub-frame 0, E-PDCCH(s) is not mapped in the PRB(s) that carry the PBCH and, if the frame structure is type 2, E-PDCCH(s) is not mapped on special sub frames.

Furthermore, if the location of a group of PRBs carrying E-PDCCH(s) is intended for a group of UEs, the PRBs are communicated to that specific group of UEs via a single legacy PDCCH in the form of a Guiding PDCCH as described above, which is transmitted in the common search space within the Pcell control region illustrated as item (250) in FIG. 3. It can be seen that, using this method of mapping, legacy UE(s) can be operated in the system 10 and the physical channels are mapped as per normal in the Pcell and/or SCell regardless of the existence of Release 11 LTE capable UE(s) in the system 10.

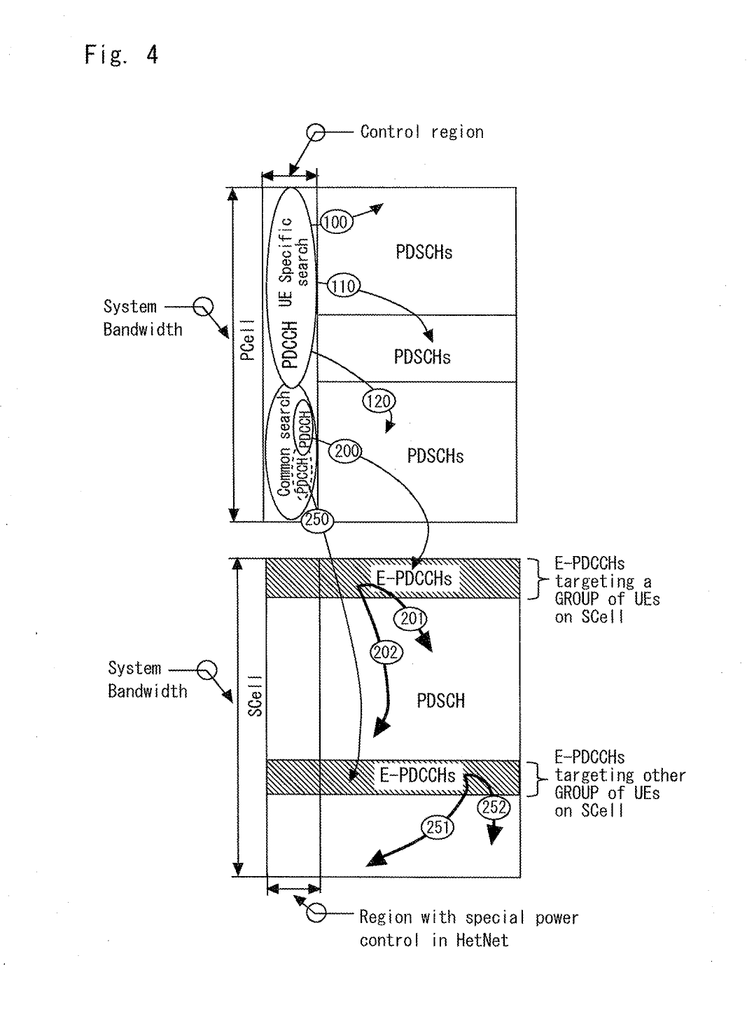

A third method of mapping E-PDCCH(s) supports carrier aggregation with semi cross carrier scheduling and is exemplary illustrated in FIG. 4. In this method, the E-PDCCH(s) is mapped:
on a secondary carrier component or Secondary cell (SCell) to provide L1 control information for the reception/transmission and decoding/encoding of the associating PDSCH(s)/PUSCH(s) scheduled on the SCell—this is the case for carrier aggregation with semi cross carrier scheduling—as illustrated as items (201), (202), (251) and (252) in FIG. 4
on a PRB (Physical Resource Block) basis
on a single slot of a sub-frame or across two slots of a sub-frame on the same PRB aiming to achieve time diversity
on a group of localised or distributed PRB(s) aiming to achieve frequency beamforming gain or frequency diversity respectively, as well as to support frequency domain ICIC on E-PDCCH(s)
in a region corresponding to L1/2 Control Region of a Pico cell in a heterogeneous network deployment, with special power control so as to reduce interference to L1/2 control channels of the Pico cell which operates on the same carrier frequency
on a group of PRB(s) by group of PRB(s) basis with each group of PRB(s) carrying E-PDCCH(s) for being monitored and blind decoded by a specific group of UEs which are subject to similar channel conditions
on RE(s) (Resource Element) which are not reserved for CRS (Cell Reference Signal), PRS (Positioning Reference Signal), CSI-RS (Channel State Information Reference Signal), PSS (Primary Synchronisation Signal), and SSS (Secondary Synchronisation Signal).

Also, if the frame structure is type 2, E-PDCCH(s) are not be mapped on special sub-frames. Furthermore, the location of a group of PRBs carrying E-PDCCH(s) on the SCell intended for a group of UEs is communicated to that specific group of UEs via a single legacy PDCCH in the form of a Guiding PDCCH as described above, which is transmitted in the common search space within the Pcell control region as illustrated as item (200) or (250) in FIG. 4. If multiple groups of PRBs carrying E-PDCCH(s) are intended for multiple groups of UEs, the Guiding PDCCH(s) can be joined coded to save space (or can be separately coded). In this way, mapping for the legacy UE(s) is performed for the physical channels as per normal in the Pcell and/or SCell regardless of the existence of Release 11 LTE capable UE(s).

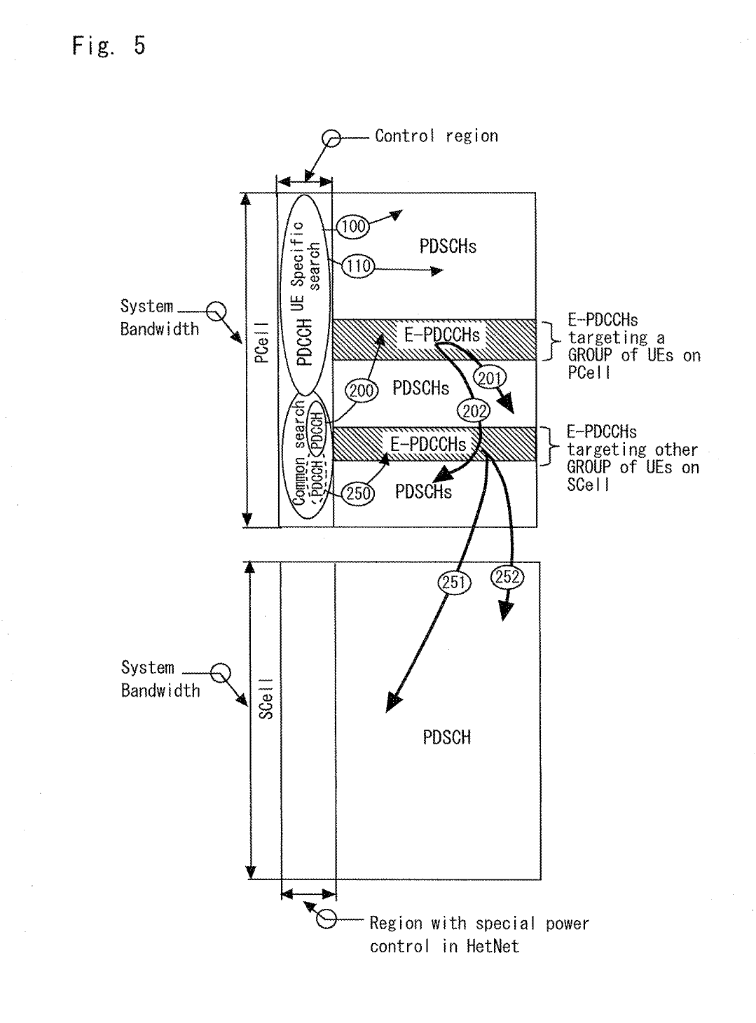

A fourth method of mapping E-PDCCH(s) supports carrier aggregation with a mix of intra carrier and cross carrier scheduling of Physical Downlink Shared Channel (PDSCH), and is exemplary illustrated in FIG. 5. In this method, the E-PDCCH(s) is mapped:
on the Primary carrier component or Primary Cell (Pcell) to provide L1 control information for the reception/transmission and decoding/encoding of associating PDSCH(s)/PUSCH(s) scheduled on the Pcell and SCell—this is the case for carrier aggregation with a mix of intra carrier and cross carrier scheduling as illustrated—as items (202) and (201) and (251) and (252) in FIG. 5
on a PRB (Physical Resource Block) basis
on a single slot of a sub-frame or across two slots of a sub-frame on the same PRB aiming to achieve time diversity
on a group of localised or distributed PRB(s) aiming to achieve frequency beamforming gain or frequency diversity respectively, as well as to support frequency domain ICIC
in a region that is not occupied by L1/2 Control Region of the Pcell so there is no impact on the legacy PDCCH
on group of PRB by group of PRB basis with each group of PRB carrying E-PDCCH(s) for being monitored and blind decoded by a specific group of UEs which are subjected to similar channel condition
on RE(s) (Resource Element) which are not reserved for CRS (Cell Reference Signal), PRS (Positioning Reference Signal), CSI-RS (Channel State Information Reference Signal), PSS (Primary Synchronisation Signal), and SSS (Secondary Synchronisation Signal).

Also, if the sub-frame is the sub-frame 0, E-PDCCH(s) is not mapped in the PRB(s) that carry the PBCH and, if the frame structure is type 2, E-PDCCH(s) is not mapped on special sub-frames. The location of a group of PRBs carrying E-PDCCH(s) intended for a group of UEs is communicated to that specific group of UEs via a single legacy PDCCH in the form of a Guiding PDCCH as described above, which is also transmitted in the common search area within the Pcell control region and illustrated as item (200) or (250) in FIG. 5.

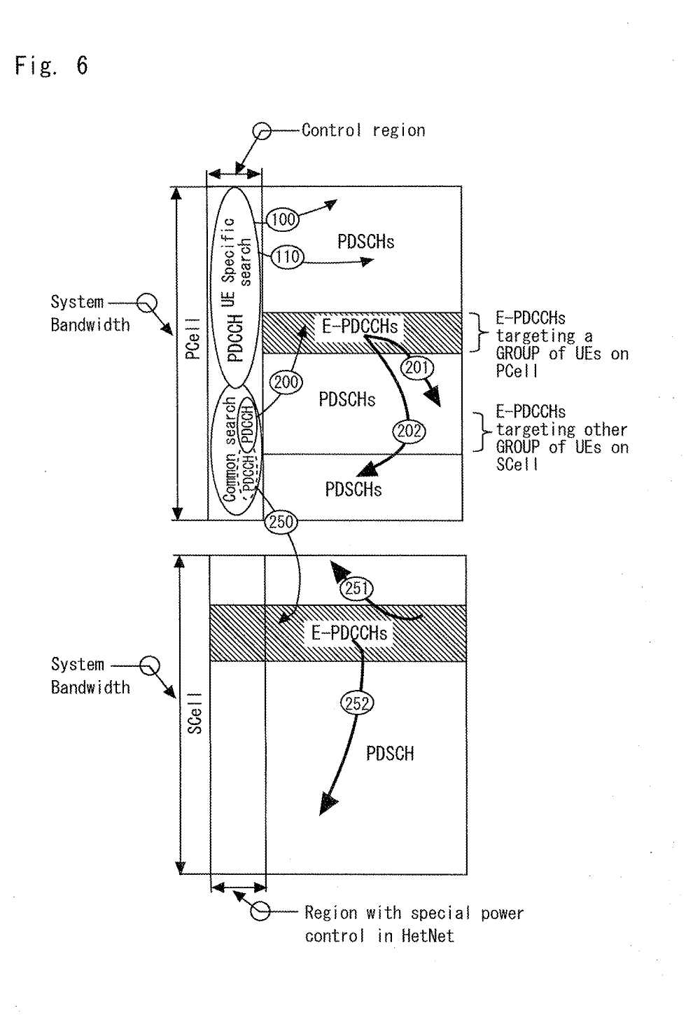

A fifth method of mapping of E-PDCCH(s) is a combination of the first and third methods, which support carrier aggregation, with E-PDCCH(s) being mapped on both the Pcell and SCell. This method of mapping is exemplary illustrated in FIG. 6.

An advantage of the above described mapping methods is that the eNodeB 11 is able to dynamically configure a cell under its control to utilize all of these methods in its operation to adapt to cell condition, channel condition and environment via use of the E-PDCCH mapping module 34. The eNodeB 11 can also apply each of the above described methods on a sub-frame basis.

In an embodiment, the UE 13 is configured to support the reception of the Physical Downlink Shared Channel (PDSCH) and/or the transmission of the Physical Uplink Shared Channel (PUSCH) being scheduled on the Pcell, or SCell, or both the Pcell and SCell, using Guiding PDCCH and E-PDCCH(s) as channels for its fast signalling. In this embodiment, E-RNTI (Enhanced PDCCH RNTI) is introduced to the system 10 which allows the eNodeB 11 to configure:
LTE Release 11 UE(s) (e.g. UE 13) to operate as legacy UE(s)
LTE Release 11 UE(s) to operate with respect to received E-PDCCH.

The E-RNTI is used, generally by a group of UEs, which are monitoring and blind decoding the same multiplexed E-PDCCH(s).

Furthermore, the Guiding PDCCH, as described above, is introduced to the system 10. The Guiding PDCCH is:
mapped on the Pcell L1/2 Control region within the common search space
has its Cyclic Redundancy Check (CRC) scrambled with the E-RNTI—the benefit of PDCCH with E-RNTI scrambled CRC is that it will eliminate the false alarm of the legacy UE(s) which are operating in the same control region and search space and allow a controlled group of LTE Release 11 UEs to be able to correctly receive the Guiding PDCCH
able to carry DCI (Downlink Control Information) in the form of Enhance DCI (E-DCI).

The E-DCI includes, but is not limited to, the following control information:
PRB(s) allocation and scheduling information for E-PDCCH mapping
E-PDCCH modulation schemes (including, but not limited to, QPSK, 16-QAM and 64-QAM)
E-PDCCH transmission schemes or modes
intra carrier E-PDCCH scheduling (e.g. methods one, two and four described above) or cross carrier E-PDCCH scheduling (e.g. method three).

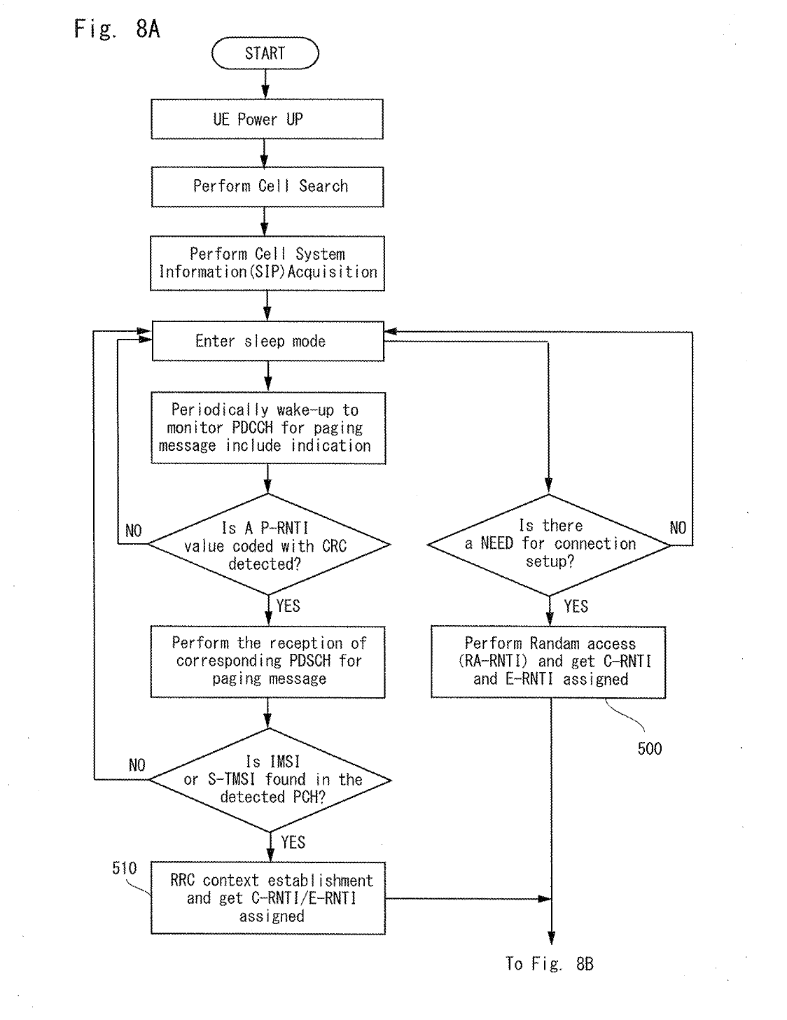

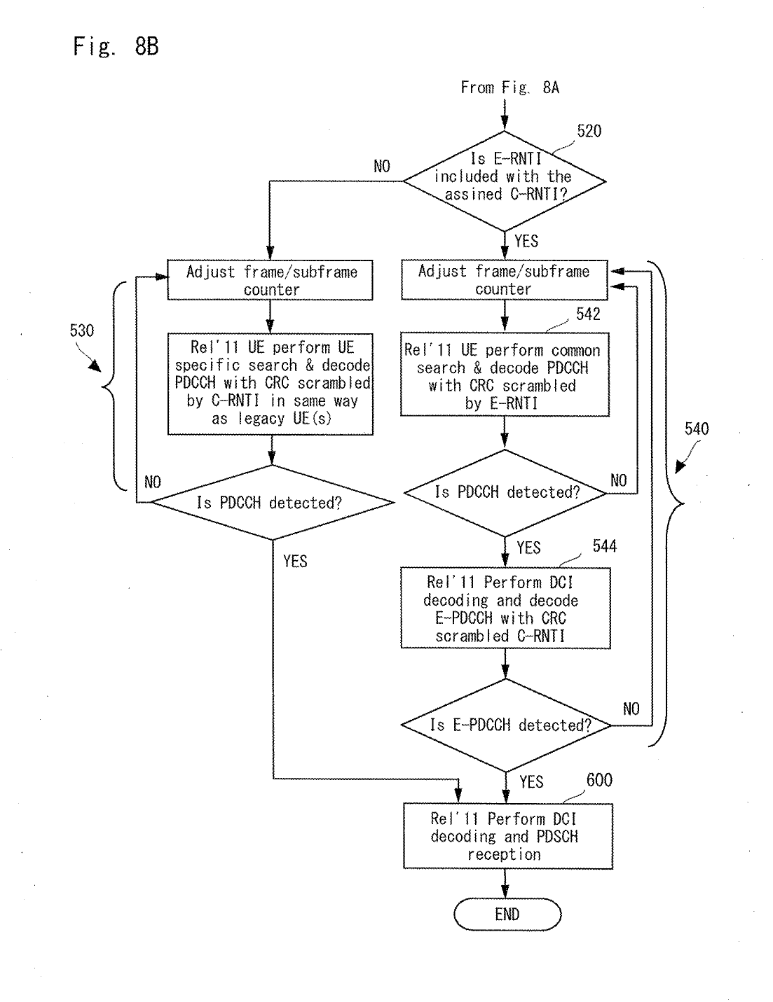

The introduction point on the legacy LTE access procedure where the E-RNTI can be assigned to the intended LTE Release 11 UE(s) is shown in FIGS. 8A and 8B. In reference to this LTE access procedure, the LTE access procedure starts with:

1. UE powering up

2. UE performing cell search procedure

3. UE performing Cell System information Acquisition, and then

4. UE entering sleep mode if there is no need to establish connection setup with the network.

As shown in FIG. 8A, there are two scenarios which can be started from the connection setup querying phase. Firstly, if there is a need for connection setup by the UE then:

a. the UE performs random access procedure and using a RA-RNTI that it obtained in the “Cell System information Acquisition” phase for the reception of PDCCH in the ‘Random Access Response’ phase

b. in the last step of the random access procedure (“Contention Resolution”), the LTE Release 11 capable UE is assigned or promoted to Cell Radio Network Temporary Identifier (C-RNTI) and assigned a Enhanced Dedicated Channel (E-DCH) Radio Network Temporary Identifier (E-RNTI) by the eNodeB shown as item (500) in FIG. 8A.

Secondly, if there is no need for connection setup by the UE 13, the LTE Release 11 UE periodically wakes up to perform:

a. monitoring of the PDCCH for paging indication of a paging message using the P-RNTI that it obtained in the “Cell System information Acquisition” phase for the reception of PDCCH in the ‘Random Access Response’ step

b. reception of the associated PDSCH for the paging message upon the successful paging indication detection on the PDCCH

c. if the IMSI (International Mobile Subscriber Identity) or S-TMSI is found in the detected PCH (Paging Channel), the UE moves to the phase to perform the RRC context establishment, during this phase the LTE Release 11 capable UE is assigned C-RNTI and the E-RNTI by the eNodeB as indicated as item (510) in FIG. 8A.

In the embodiment, a Release 11 UE is configured to receive a PDSCH according to a reception procedure. In reference to FIG. 8B, the PDSCH reception procedure, starting from the step that the C-RNTI and E-RNTI have been assigned to the LTE Release 11 capable UE, further includes the following steps. If the E-RNTI is not included with the assigned or promoted C-RNTI, the Release 11 capable UE performs the PDSCH reception in the same way that the legacy LTE UE(s) does. That is:
the Release 11 capable UE performs UE specific search and decoding of PDCCH with CRC scrambled by C-RNTI
if a PDCCH is detected and DCI is successfully decoded, the Release 11 capable UE performs the reception and decoding of the associating PDSCH and or the encoding and transmission of the associating PUSCH using the control information provided in the detected DCI as illustrated as item (530) in FIG. 8B.

If the E-RNTI is included with the assigned C-RNTI, on the other hand, the Release 11 capable UE performs the PDSCH reception procedure. That is:
The Release 11 capable UE performs a common search and decode of the Guiding PDCCH with CRC scrambled by E-RNTI
upon the successful detection of the Guiding PDCCH, the Release 11 capable UE decodes the E-DCI for the control information in reception and decoding of the E-PDCCH(s)
the Release 11 capable UE performs reception and blind-decoding of the E-PDCCH with the CRC scramble C-RNTI—the reception of the E-PDCCH(s) can be either on the Pcell or on the SCell and the Release 11 capable UE shall be told by the eNodeB via the Guiding PDCCH
If an E-PDCCH is detected and DCI is successfully decoded, the Release 11 capable UE performs the reception and decoding of the associating PDSCH and/or encoding and transmission of the associating PUSCH using the control information provided in the detected DCI.

Furthermore, it will be appreciated by those persons skilled in the art that the E-PDCCH(s) shall be link-adapted in a term modulation scheme, transmission scheme and PRB(s) allocation.

In an embodiment, the E-PDCCH coding structure enables the system 10 to achieve a higher modulation, multilayer and MU-MIMO (Multi User MIMO) modes of operation, multi-layer mapping and precoding, and non-codebook based precoding in associate with the DMRS (Demodulation Reference Signal).

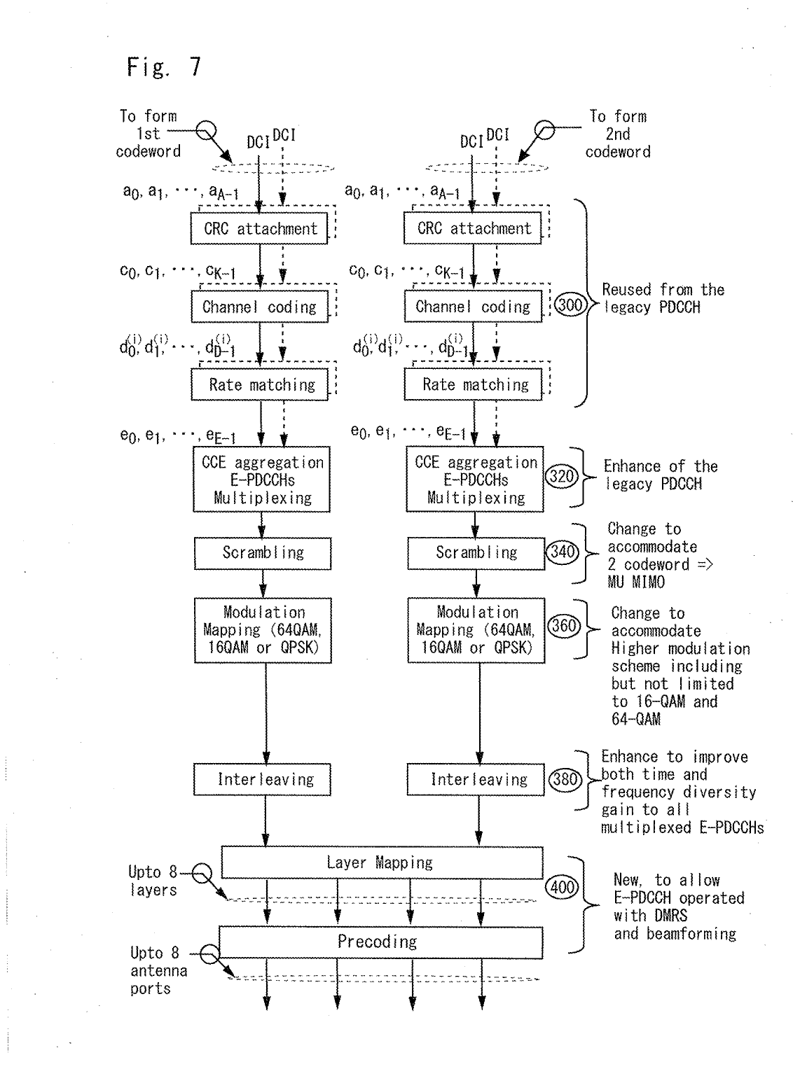

In reference to FIG. 7, a method of forming the E-PDCCH coding structure is shown. The E-PDCCH coding structure is formed using the following functions or group of functions:

1. legacy PDCCH coding chain functions (300) including CRC attachment, Channel coding and Rate matching: it can be seen that only a small change to legacy rate matching is performed to take into account higher modulation schemes (including but not limited to 16-QAM & 64-QAM) and multi layers

2. CCE aggregation & E-PDCCH Multiplexing (320): this function is the enhancement of the legacy PDCCH and provides that only E-PDCCH belonging to a group of UEs which are subjected to similar channel conditions, environment and/or belonging to a particular beam within a grid of beams shall be multiplexed together

3. scrambling (340): the output block bit stream from the CCE Aggregation and E-PDCCH multiplexing function shall be scrambled according to the following equation:

\tilde{b}^{(q)}(i)=(b^{(q)}(i)+c^{(q)}(i)mod 2
Where:
   qε{0,1} in the case of one code word transmission i.e. SU-MIMO, q=0
c^{(q)}(i) as specified in section 7.2 of the 3GPP specification TS 36.211
the scrambling sequence generator shall be initialised at the start of each sub-frame, where the initialisation value of

cᵢₙᵢₜ=q·2¹³+└nₛ/2┘·2⁹+N_{ID}^{cell}

4. modulation function (360): this function is changed to accommodate higher modulation scheme such as 16-QAM or 64-QAM

5. interleaving: this function performs symbol level block interleaving aiming to give each E-PDCCH similar time and frequency diversity gain when being mapped on the allocated PRB(s)

6. layer mapping and precoding: this function is inherited from the legacy PDSCH which is specified in the 3GPP specification TS 36.211 section 6.3.3 and 6.3.4.

Referring back to FIGS. 8A and 8B, it can be seen that, in an embodiment, a UE, in data communication with an eNodeB over a LTE wireless communication system, is configured to receive E-PDCCH(s) comprising control information from the eNodeB. In the embodiment shown in this Figure, the UE detects Guiding PDCCH, and performs E-DCI decoding on the Guiding PDCCH to receive E-PDCCH for configuring the UE to communicate data with the eNodeB over the LTE wireless communication system. The UE is then able to can configure uplink and downlink channels for communicating data with the eNodeB to receive and/or transmit said data to/from the eNodeB accordingly.

It is to be understood that various alterations, additions and/or modifications may be made to the parts previously described without departing from the ambit of the present invention, and that, in the light of the above teachings, the present invention may be implemented in software, firmware and/or hardware in a variety of manners as would be understood by the skilled person.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

Throughout the description and claims of this specification, the word “comprise” and variations of the word, such as “comprising” and “comprises”, is not intended to exclude other additives, components, integers or steps.

This application is based upon and claims the benefit of priority from Australian Provisional Patent Application No. 2011905034, filed on Dec. 2, 2011, the disclosure of which is incorporated herein in its entirety by reference.

### INDUSTRIAL APPLICABILITY

The present invention is applied to a method of providing control information for UEs in data communication with an eNodeB over a LTE wireless communication system, and is particularly applied to the purpose of using E-PDCCH for configuring the UEs to communicate data with the eNodeB over the LTE wireless communication system.

### REFERENCE SIGNS LIST

10 LTE WIRELESS COMMUNICATION SYSTEM
11 eNodeB
12 TRANSMITTER CONTROLLER
13 UE
14 RECEIVER CONTROLLER
16 BASEBAND SIGNAL PROCESSOR
18 AMC PROCESSOR
20 PRECODING AND BEAMFORMING PROCESSOR
22A-22N, 28A-28N ANTENNA
24 DL CHANNEL
26 UL CHANNEL
30 PDCCH ENCODING MODULE
32 E-PDCCH ENCODING MODULE
34 E-PDCCH MAPPING MODULE
36 CSI-RS MODULE
38 CRS
40 DMRS
41 CONTROLLER
42 RECEIVER SIGNAL PROCESSOR
43 PDCCH/E-PDCCH/PDSCH RECEPTION MODULE
44 TRANSMITTER SIGNAL PROCESSOR

1. A method implemented in a base station of providing control information to a user equipment (UE) over a wireless communications system, the method comprising:
scrambling an enhanced physical down link control channel (E-PDCCH) comprising the control information;
modulating the E-PDCCH;
mapping the E-PDCCH on an allocated physical resource block (PRB); transmitting the E-PDCCH to the UE;
mapping the E-PDCCH on the allocated PRB on a primary carrier component of the wireless communications system; and
providing full cross carrier scheduling on at least one of physical down link shared channel (PDSCH) and physical uplink shared channel (PUSCH),
wherein the UE communicates over the wireless communications system according to the control information, and
wherein both localised and distributed transmission is supported for the E-PDCCH.

2. (canceled)

3. (canceled)

4. The method as claimed in claim 1,
wherein mapping the E-PDCCH on the allocated PRB is dynamically configured.

5. The method as claimed in claim 4,
wherein the dynamic configuration is on a sub-frame basis.

6. The method as claimed in claim 1, further comprising:
mapping the E-PDCCH on the allocated PRB using a single carrier component of the wireless communications system.

7. The method as claimed in claim 6, further comprising:
mapping the E-PDCCH on the allocated PRB using intra carrier mapping of the single carrier component.

8. The method as claimed in claim 1, further comprising:
mapping the E-PDCCH on the allocated PRB on a secondary carrier component of the wireless communications system; and
providing semi cross carrier scheduling on at least one of physical down link shared channel (PDSCH) and physical uplink shared channel (PUSCH).

9. (canceled)

10. (canceled)

11. (canceled)

12. The method as claimed in claim 1, further comprising:
mapping in a common search space of a primary carrier component a guiding PDCCH comprising enhanced downlink control information (E-DCI) for the UE,
wherein the UE decodes the E-PDCCH on the allocated PRB on at least one of a primary carrier component and a secondary carrier component of the wireless communications system.

13. The method as claimed in claim 12, wherein the guiding PDCCH comprises a cyclic redundancy check (CRC), and
wherein the CRC is scrambled with an assigned enhanced dedicated channel radio network temporary identifier (E-RNTI).

14. The method as claimed in claim 13, further comprising:
assigning the E-RNTI to a UE in the wireless communications system.

15. The method as claimed in claim 14, further comprising:
assigning a cell radio network temporary identifier (C-RNTI) to the UE; and
assigning the E-RNTI to the UE,
wherein the UE receives at least one of physical downlink shared channel (PDSCH) and physical uplink shared channel (PUSCH) and decodes said at least one of PDSCH and PUSCH according to the DCI.

16. The method as claimed in claim 1, further comprising:
encoding the E-PDCCH to form an E-PDCCH coding structure by performing at least one of
1) a PDCCH coding chain function on the control information,
2) Control Channel Element (CCE) aggregation and E-PDCCH multiplexing to enhance the PDDCH coding chain function,
3) scrambling to accommodate a multi user multiple input multiple output (MU-MIMO) wireless communications system,
4) a higher modulation scheme to improve E-PDCCH throughput,
5) interleaving to improve time and frequency gain of the E-PDCCH, and
6) layer-mapping and precoding to allow the E-PDCCH to operate with demodulation reference signal (DMRS) and beamforming.

17. A method implemented in a user equipment (UE) of receiving control information from a base station over a wireless communications system, the method comprising:
receiving an enhanced physical down link control channel (E-PDCCH) from the base station; and
communicating over the wireless communications system according to the control information,
wherein the E-PDCCH comprises the control information,
wherein the E-PDCCH is scrambled and modulated by the base station and mapped on an allocated physical resource block (PRB) by the base station on a primary carrier component of the wireless communications system,
wherein full cross carrier scheduling is provided by the base station on at least one of physical down link shared channel (PDSCH) and physical uplink shared channel (PUSCH), and
wherein both localised and distributed transmission is supported for the E-PDCCH.

18. (canceled)

19. (canceled)

20. A method implemented in a wireless communications system of providing control information from a base station to a user equipment (UE), the method comprising:
scrambling an enhanced physical down link control channel (E-PDCCH) comprising the control information;
modulating the E-PDCCH;
mapping the E-PDCCH on an allocated physical resource block (PRB) on a primary carrier component of the wireless communications system;
transmitting the E-PDCCH from the base station to the UE;
communicating over the wireless communications system according to the control information; and
providing full cross carrier scheduling on at least one of physical down link shared channel (PDSCH) and physical uplink shared channel (PUSCH),
wherein both localised and distributed transmission is supported for the E-PDCCH.

21. (canceled)

22. (canceled)

23. (canceled)

24. (canceled)

25. (canceled)

26. (canceled)

27. (canceled)

28. (canceled)
